(19) United States
(12) Patent Application Publication
(10) Pub. No.: US 2026/0185954 A1
(43) Pub. Date: Jul. 2, 2026

(54) Biocolonisation sensor

(71) Applicants: Nantes Université, NANTES (FR); CENTRE NATIONAL DE LA RECHERCHE SCIENTIFIQUE, PARIS (FR)

(72) Inventors: Franck Schoefs, Sucé sur Erdre (FR); Bertrand Garnier, Nantes (FR); Ziad Maksassi, Nantes (FR); Ahmed Gueled, La Chevallerais (FR)

(21) Appl. No.: 18/865,861

(22) PCT Filed: May 17, 2023
(86) PCT No.: PCT/EP2023/063245

§ 371 Date: Nov. 14, 2024

(30) Foreign Application Priority Data
May 18, 2022 (FR) 2204752

(51) Int. Cl. G01N 25/18

(52) U.S. Cl. CPC G01N 25/18

(57) ABSTRACT

A temperature measuring device configured to be applied to an immersed component. The device includes: a heating element controlled by a heating circuit; a temperature sensor controlled by a temperature measuring circuit, the sensor being intended to sense temperature in the vicinity of the heating element over a predetermined period; a memory module for storing the temperatures obtained by the temperature measuring circuit; a data transmitter for transmitting the data stored in the memory; and a first part including a power supply powering the temperature measuring circuit and the heating circuit, the temperature measuring circuit, the memory and the transmitter. The first part is distinct from a heating and measuring part, and at least a portion of the first part P1 has a treatment to limit biocolonization. The disclosure also includes systems and methods involving implementing such a device.

### TECHNICAL FIELD

The disclosure relates to the measurement of biocolonisation. The disclosure relates more particularly to the measurement of biocolonisation in a marine environment. The disclosure relates still more specifically to a device for measuring biocolonisation in a marine medium.

### PRIOR ART

Floating wind turbine projects are developing globally in a promising manner. One of their key components is the dynamic power cable enabling wind turbines to be connected to their electrical substation and to the underwater energy grid. This electrical power transmission cable obtained from the wind turbine is a key component of the electrical system. Its operation must therefore be carefully monitored. It is intellectually easy to think that this cable presents no operating difficulty because it rests on the seabed and is ultimately subject to few stresses compared with the wind turbine itself. However this idea should be challenged: this cable is itself also subject to the effects of time, in particular due to the little-known but strongly-impacting effect of biocolonisation. Here, biocolonisation means the development of marine concretions (algae, mussels, oysters) which can reach several tens of centimetres in thickness. This biocolonisation paradoxically takes place under the effect of the operation of the cable: the passage of a significant amount of electricity in the cable causes it to heat up. This heating up of the cable causes local heating up of the seawater that is in contact with the cable. This heating up itself promotes biocolonisation, by making the medium close to the cable more favourable to the formation of concretions. However, conventionally, the parameters of power cable manufacturer include the capacity of the cable to cool-down due to the medium (i.e. due to the seawater which surrounds it). The biocolonisation thus leads to a variation, in situ, of the initial parameters taken into account during the manufacture of the power cable. In other words, the transport of electricity can increase the temperature of the water around the cable, which leads to a more significant biocolonisation of the cable.

Moreover, the biocolonisation will impact the dynamic behaviour of the cable due to thermal screening, additional mass and changes to the roughness. Among the major effects resulting from biocolonisation, in particular the hydrodynamic stresses in particular should be noted, which modify the behaviour in the event of storms or fatigue; but also the thermal effects around the cable. Taking into account the variety of elements of the cable (flotation modules, stiffeners) and the variety of biological environments, modelling this phenomenon remains a challenge. It is therefore necessary to understand the role of biocolonisation, with all its variability, in order to focus studies on the particular components.

It is thus necessary not only to address the effect of biocolonisation of the dynamic umbilicals on heat exchange, but also to possess the means for measuring, in real time or in delayed time, the extent of the biocolonisation itself. It is also necessary to measure this biocolonisation in order, in particular, to evaluate the need for cable maintenance or replacement.

### SUMMARY

The disclosure was conceived with these disadvantages of the prior art in mind. The disclosure relates more particularly to a device for indirectly measuring biocolonisation. More particularly, the disclosure relates to a temperature measuring device configured to be applied to an immersed component in order to evaluate the biocolonisation. Such a temperature measuring device comprises:
a heating element controlled by a heating circuit;
at least one temperature sensing module, controlled by a temperature measuring module, the sensing module being intended to sense the temperature in the vicinity of the heating module, during a predetermined period;
at least one memory module for storing the temperatures obtained by the temperature measuring module;
a data transmission module for transmitting the data stored in the memory module.

Such a device also comprises a part P1 comprising, on the one hand, power supply means of the temperature measuring device and, on the other hand, a module comprising in particular the heating circuit, the temperature measuring module, the memory module, and the transmission module. This part is distinct from a so-called heating and measuring part P2, and at least one portion of part P1 comprises a treatment to limit biocolonisation.

Hence, it is possible to record temperatures in the vicinity of the heating element incorporated in the device, for a predetermined period of time, during and after a period during which the heating element is active and heated. Such a configuration of the device, comprising the two parts P1 and P2, enables optimum adaptation of this device to the cable on which it is installed, which enables, on the one hand, optimum measurement of the temperature data and, on the other hand, optimum processing of these measured/recorded data. In addition, the treatment applied to part P1 and limiting biocolonisation, advantageously makes it easier to repair the device when it is immersed and bonded/fixed to a cable. It is also simpler to ensure its underwater maintenance. The device can comprise an autonomous power source, for example a set of batteries or accumulators for powering the heating and the electronics modules intended to control and to measure temperature as a function of time, keeping the device in sleep mode.

According to a particular feature, the so-called heating and measuring part P2, of overall hemicylindrical shape, includes a plurality of layers comprising:
a supporting layer, in contact with the outer surface of the immersed component;
an insulating layer, insulating the supporting layer;
a heating layer, comprising said at least one heating element;
a so-called accumulating metallic layer, for accumulating the heat produced by the heating layer.

Such a configuration makes it possible to control the conditions for heating and temperature measurement over time.

According to a particular feature, the device comprises at least two temperature sensing modules and at least a first temperature sensing module is inserted within the accumulating layer, and at least a second temperature sensing module is inserted within the insulating layer.

According to a particular feature, the data transmission module comprises an acoustic transmission component.

According to another aspect, the invention also relates to a system for obtaining data representative of a biocolonisation of a component immersed in the open sea, the system being characterised in that it comprises at least one temperature measuring device as described in the present document and at least one device for processing temperature response data transmitted by said at least one temperature measuring device, said processing device being able to characterise the biocolonisation of the immersed component as a function of the temperature response data.

The temperature response data can be time stamped temperature data from the temperature sensing modules, which are stored in a memory. They are a function of time and obtained over a short period (typically less than 15 minutes).

According to another aspect, the invention also relates to a method for obtaining data representative of biocolonisation of an immersed component. Such a method is implemented by a system as described in the present document, and such a method comprises the following steps:
a step of heating, during a predetermined period, said heating element of said at least one temperature measuring device;
a plurality of steps of measuring the temperature resulting from the heating step;
a step of storing the measured data, in particular comprising the timestamping of these data; and subsequently,
a step of transmitting the stored data, followed by a step of characterising the biocolonisation using the transmitted temperature data.

According to a particular feature, the step of characterising the biocolonisation using the transmitted temperature data comprises calculating a heat transfer coefficient h of the underwater fauna and flora constituting the biocolonisation, using a 1D analytical thermal model or a conductive thermal model solved by the quadrupole method.

According to a preferred implementation, the various steps of the methods according to the present disclosure are implemented by one or more software or computer programmes, comprising software instructions intended to be executed by a data processor of an execution terminal according to the present technique and being designed to control the execution of various steps of the methods, implemented at a communication terminal, a remote server and/or chain of units, within the scope of a distribution of the processes to be carried out and determined by a scripted source code or a compiled code.

Consequently, the present technique also targets programmes that can be executed by a computer or by a data processor, these programmes including instructions to control the execution of steps of the method such as mentioned above.

A programme may use any programming language, and be in the form of source code, object code, or byte code between source code and object code, such as in a partially compiled form, or in any other desirable form.

The present technique also targets an information medium that can be read by a data processor, and including instructions of a programme such as mentioned above.

The information medium may be any entity or terminal capable of storing the programme. For example, the medium may include a storage means, such as a ROM, for example a CD ROM or a microelectronic circuit ROM, or also a magnetic recording means, for example a mobile medium (memory card) or a hard drive or an SSD.

On the other hand, the information medium may be a transmissible medium such as an electrical or optical signal, which may be routed via an electrical or optical cable, by radio or by other means. The programme according to the present technique may in particular be downloaded on an Internet type network.

Alternatively, the information medium may be an integrated circuit in which the programme is incorporated, the circuit being suitable for executing or for being used in the execution of the method in question.

According to an embodiment, the present technique is implemented by means of software and/or hardware components. In this regard, the term “module” may correspond in this document to a software component as well as to a hardware component or to a set of software and hardware components.

A software component corresponds to one or more computer programmes, one or more subprogrammes of a programme, or more generally to any element of a programme or of software capable of implementing a function or a set of functions, according to what is described below for the module concerned. Such a software component is executed by a data processor of a physical entity (terminal, server, gateway, set-top-box, router, etc.) and is capable of accessing the hardware resources of this physical entity (memories, recording media, communication bus, input/output electronic cards, user interfaces, etc.).

In the same manner, a hardware component corresponds to any element of a hardware assembly capable of implementing a function or a set of functions, according to what is described below for the module concerned. This may concern a hardware component that can be programmed or with an integrated processor for executing software, for example an integrated circuit, a chip card, a memory card, an electronic card for executing firmware, etc.

Each component of the system described above of course implements its own software modules. The various embodiments mentioned above can be combined with one another to implement the present technique.

### BRIEF DESCRIPTION OF THE FIGURES

Other aims, features and advantages of the disclosure will become clearer on reading the following description, which is given by way of a simple illustrative and non-limiting example, in relation to the figures, including:

FIG. 1 shows a section through a part of the temperature measuring device;

FIG. 2 illustrates the various modules of the temperature measuring device;

FIG. 3 is a section illustrating a hemicylindrical configuration of a portion of the temperature measuring device on an immersed element;

FIG. 4 schematically illustrates the implemented method for measuring and processing;

FIG. 5 shows an embodiment of the temperature measuring device;

FIG. 6 is a sectional view of the second part of the temperature measuring device shown as an example in FIG. 5.

FIG. 7 schematically illustrates the programming structure of the temperature measuring device.

### DETAILED DESCRIPTION

The same elements bear the same reference signs in the various figures. In particular, the structural and/or functional elements that are common to the various exemplary embodiments can have the same reference signs and can have identical structural, dimensional and material properties. For the purposes of clarity, only the steps and elements that are useful for understanding the described exemplary embodiments are shown and described in detail. In particular, circuits for generating a signal and for controlling the frequency and intensity of this signal, as well as circuits for controlling and receiving values supplied by the sensors, are not described in detail, the exemplary embodiments described being compatible with usual such circuits. Unless otherwise specified, when reference is made to two elements being connected to each other, this means directly connected without intermediate elements other than conductors, and when reference is made to two elements that are linked or coupled together, this means that these two elements can be connected or be linked or coupled by means of one or more other elements. In the description which follows, when reference is made to absolute position qualifiers, such as the terms “front”, “rear”, “top”, “bottom, “left”, “right”, etc., or relative position qualifiers, such as the terms “above”, “below”, “upper”, “lower”, etc., or to orientation qualifiers, such as the terms “horizontal”, “vertical”, etc., reference is made unless otherwise specified to the orientation of the figures. Unless otherwise specified, the expressions “around”, “approximately”, “substantially”, and “of order” mean to within 20%, preferably to within 5%.

As previously disclosed, heat exchange around underwater cables, in particular electrical cables, is altered to a greater or lesser degree by biocolonisation (the development of marine concretions such as algae, mussels, oysters, etc.), consequently with higher temperature levels ultimately inducing a shorter service life of the cables. Monitoring the growth of biocolonisation, in real-time or semi-real-time, with its effects on heat exchange is therefore important for maintenance, in particular maintenance of offshore wind turbines.

Hence, the disclosure aims to evaluate the progression of the biocolonisation of cables and pipelines resting on the seabed. The disclosure is interesting, in particular, for evaluating the need for cleaning or replacement of such cables or pipelines. The disclosure comprises two independent elements, but providing a certain complementarity. According to a first aspect, a device is disclosed which can enable a measurement of the biocolonisation of underwater cables (such a device, also called a sensor for simplicity, comprises, for example, a pulsed or modulated heating module associated with a subsurface temperature sensor, which operates in unsteady mode and which is configured to be applied to an immersed component). According to a second aspect, a method is disclosed for measuring biocolonisation using the data supplied by the device for measuring biocolonisation. This method is based on a principle of indirect measurement of biocolonisation. More particularly, in this second aspect, the disclosure consists of measuring the influence of biocolonisation on the heat exchange of an immersed component (a cable, for example, but also a pipeline or other immersed elements subject to biocolonisation).

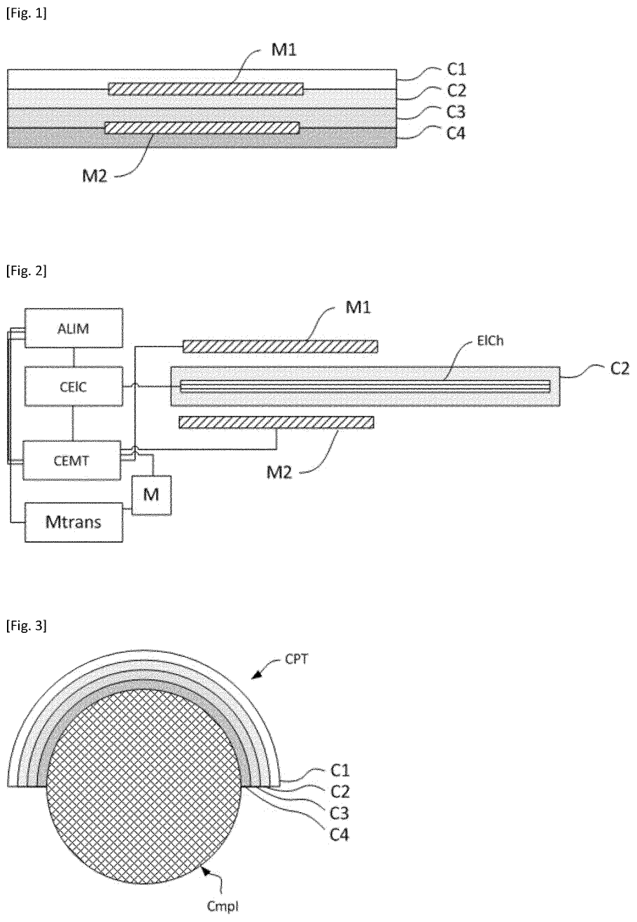

The disclosure thus comprises a sensor to be incorporated or installed on an immersed component, said sensor being able to supply data relating to a temperature response. FIGS. 1 to 3 show the general principles of the sensor that is the object of the disclosure. Such a sensor comprises a combination of a plurality of layers of materials, included in a part (P2) of the device: an upper layer (C1) (for example made of stainless steel) the upper face of which is in contact with the medium (water, for example), a layer (C2) located under the upper layer, comprising one or more heating elements, a thermoplastic layer (C3) (for example, polyethylene) located under the layer comprising the heating elements, a lower layer (C4), referred to as the contact layer, formed for example of rubber, the lower face of which is in contact with the element to be monitored (the cable, pipeline, etc.). This combination of layers also includes at least two temperature measuring components (M1, M2) (for example thermocouples) located between layer C1 and layer C2 on the one hand, and between layer C3 and layer C4 on the other hand.

More particularly, the sensor which is the object of the disclosure is in the form of an assembly, comprising within it a heating layer (C2) comprising at least one sheet heating element (EICh), comprising connection means to a heating circuit (CEIC), which delivers, as explained below, via the connection means, an electrical pulse of predetermined duration and intensity. As shown in FIG. 3, the shape of the sensor is adapted so that it matches the configuration of the immersed component: in FIG. 3, which is a schematic sectional view, the sensor (CPT) is installed on a cylindrical immersed component (CmpI) and the bottom of the sensor (represented by the layer C4) thus has a concave shape matching the cylindrical shape of the immersed component. Of course, the shape of the sensor is in any case adapted to the shape of the immersed component (CmpI). The heating circuit (CEIC) is connected in turn to a power supply (ALIM). In the example shown, the power supply is in the form of a battery, incorporated in the sensor. Such an implementation is possible depending on the intended use of the sensor. More specifically, under operating conditions, since the biocolonisation process is slow, the sensor is used infrequently (four to six times per year). Therefore, the energy requirements of this sensor are reduced and it is not necessary to have a continuous power supply for it. Under other operating conditions, the power supply comprises a power supply cable, for example drawn from the surface: in the case of a wind turbine at the surface, the power supply cable can be, for example, drawn from the wind turbine and the power supply for the sensor is indirectly provided by this. Finally, mixed power supply means are also possible, combining the use of a battery and means for recharging the battery, these means being, for example, in the form of a cable, as just described or in any other form suitable for the marine medium in which the sensor is located (mini-water turbine, for example).

In any case, the sensor further comprises, in this example, an electronic temperature measuring circuit (CEMT). This electronic temperature measuring circuit is activated at the start of the heating phase of the heating element. It is able to determine, over time, the variations in temperature, starting from an initial temperature (before heating), to a final temperature (which is the initial temperature, as explained below). This electronic temperature measuring circuit (CEMT) transmits, at a predefined interval, the temperatures measured over time, to an electronic analysis and storage device (not shown in the figures), which temperatures are stored in a memory M. The transmission is carried out by a transmission module (MTrans). All of these modules can be incorporated within a single same customer-manufactured electronic component. These modules can be controlled by a microprocessor or microcontroller (not shown). This transmission can be a wireless transmission (by an acoustic transmission method, for example), for example to a receiving station for this information, or can even be carried out, as with the power supply, using a cable to a suitable receiving station for this information. The power supply, heating circuit (CEIC), temperature measuring module (CEMT), memory M and transmission module (MTrans) are included in a part of the device, called P1, that is distinct from the part P2.

Once in possession of the temperatures measured over time, optionally during and after the heating phase, the electronic analysis and storage device is able to characterise the biocolonisation of the immersed component. Such a configuration thus makes it possible to record temperatures in the vicinity of the heating element incorporated in the sensor, for a predetermined period of time, during and after a period during which the heating element is active and heated. A curve showing the rise and fall of the measured temperature can thus be obtained (one curve per temperature sensing module, for example). On the basis of these data, it is then possible to characterise the biocolonisation (composition, thickness).

This characterisation comprises two parts, for example: the first part consists of determining a thickness of the concretions located at the edges of the sensors (i.e. concretions which are formed on the sensor itself and in its immediate surroundings). Hence, the cooling phase, just after the end of the heating, is used to deduce the overall heat exchange coefficient using, for example, a conductive thermal model developed using the quadrupole method. This 1D analytical thermal model can predict the temperatures and heat flows in the experimental multilayer device with a Fourier-type surface boundary condition, thus with a heat transfer coefficient. Based on the knowledge of the change in temperature measured as a function of time following pulsed heating, a parameter identification method is applied, minimising the deviations between the measured temperatures and those calculated by the thermal model developed in order to estimate the heat transfer coefficient. The heat transfer coefficient thus characterises the heat exchange around the sensor. In other words, the overall thermal resistance linked to the thickness and type of biocolonisation is evaluated. Tests carried out on the basis of the previously described sensor, have shown that for an immersed thermal sensor, the presence of a three to four cm layer of mussels reduced the heat transfer coefficient by a factor of two, which demonstrates the high sensitivity of the measurement technique to the presence of biocolonisation according to the disclosure. It should also be noted that a heat transfer coefficient reduced by a factor of two has a significant impact on the operating temperature level of an underwater electrical cable, for example.

Depending on the embodiment and operational conditions of use, the device of the disclosure comprises, in addition to the previously mentioned modules and means, means for obtaining data representative of a direction and/or speed of the water flow around the temperature measuring device. Such means can be in the form of a Doppler current meter or a propeller-type current meter. These means can be incorporated in the temperature measuring device or even be combined with the temperature measuring device, depending on the embodiments. The data obtained via these means are also stored in the memory component. These data are then transmitted, at the same time as the temperature change data.

The second part of the characterisation of the concretions consists of identifying the colonising species forming this concretion. The curves of falling temperatures are associated with one or more colonising species, on the basis of a database. More particularly, an application can link the heat exchange curves with a thickness of biocolonisation and with a given species on the basis of the database. This database comprises, for example, the ten most common colonising species (mussels, oysters, algae). The effective recognition of the colonising species can be determined or confirmed beforehand or subsequently, during a routine monitoring dive, for example, and be used to increase the volume of knowledge of the characterisation database.

The disclosure, on the other hand can also use a software block to characterise the biocolonisation, on the basis of the actually measured temperature response.

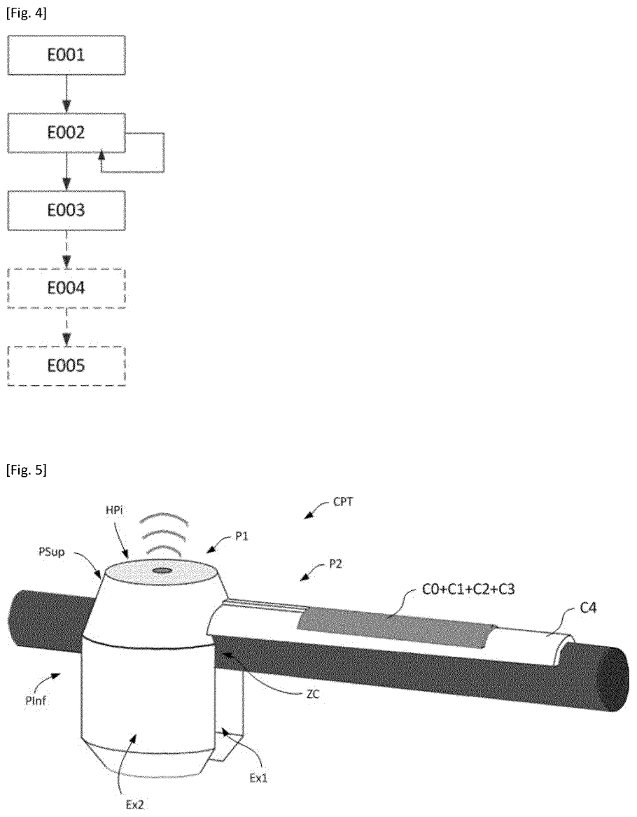

The general operating principle of the measurement method implemented using such a sensor is described in conjunction with FIG. 4 and comprises:
a heating step (E001), during a predetermined period: an electrical pulse is applied to the heating element of layer C2; this has the effect of heating this portion; the metallic layer located above the heating element conducts (and distributes) the heat produced, over all of its surface.
a plurality of temperature measuring steps (E002), in particular after the heating has stopped, for example by means of temperature sensors M1 and M2;
a step (E003) of storing the measured data, in particular comprising the timestamping of these data; and subsequently,
a step (E004) of transmitting the stored data (in particular temperature data, to an electronic analysis device); and
a step (E005) of characterising the biocolonisation using the transmitted temperature data.

The task of characterisation performed by the electronic analysis device can be based on previously performed learning (i.e. on the basis of a set of characterisation data making it possible to deduce a presence/amount/type of biocolonisation on the basis of one or more temperature data curves). More particularly, on the basis of the changes in the measured temperatures, a heat transfer coefficient h of the underwater fauna and flora constituting the biocolonisation is calculated using a 1D analytical thermal model or a conductive thermal model solved by the quadrupole method. The advantage of having at least two sensors (M1, M2), positioned at different sensor locations, is that they can each measure different temperatures (and temperature changes). Consequently, the solution to the problem of characterising the biocolonisation can use these different sources of temperature changes in order to refine the calculations.

The use of the temperature sensor according to the present disclosure comprises, for example, a step of positioning a control device of the sensor vertically above it (this device can be incorporated within a surface vessel, for example); a step of transmitting, by the control device, an acoustic command (sound or ultrasound) for implementing a data transmission (E004), these data having been obtained during previous measurement cycles, optionally periodically (steps E001 to E003). At the end of the transmission, the characterisation step (E005) is performed either directly on the vessel (depending on the available equipment), or subsequently. A cable cleaning campaign can then be considered, depending on the characterisation of the biocolonisation.

As previously specified, depending on the embodiment the operational conditions of use, the data relating to the speed of the water flow and direction of this flow can also be transmitted in order to refine the characterisation of the biocolonisation. For example, such data can be used, as a function of the geographical location of the temperature measuring device, this geographical location potentially implying the presence of underwater fauna and flora constituting a porous medium with open pores, and thus passed through by the water flow to a greater or lesser extent, which it is therefore possible to characterise more precisely through the use of data from a current meter. Various complementary features of the disclosure are possible. The sensor can thus be bonded on the immersed component (rather than clamped), with energy autonomy given that the pulse (heating) is not very frequent. The interrogation and power supply can be wired along the cable, as previously disclosed.

The disclosure has at least two other fields of application: floating offshore platforms for hydrocarbon exploitation with the monitoring of risers which transport the oil at significant temperatures (150°) and for which the problem of fatigue in the presence of biocolonisation can arise at a depth from 20 to 50 m, depending on the sites. Instrumented coupons upstream of the installation floating wind turbine sites. These coupons consist of a multilayer structure having, successively, an insulating layer, a heating element and a metal piece equipped with a thermocouple. In conjunction with FIG. 5, an exemplary embodiment will be described for the sensor shown schematically in relation with FIGS. 1, 2 and 3. In this exemplary embodiment, the sensor is autonomous and operates using a battery or accumulator power supply. As previously described, it is in two parts (P1, P2), the first part (P1) in an overall cylindrical shape and having a hollow central region (ZC), dividing the lower part (PInf) of the sensor into two hanging protrusions (Ex1, Ex2), each of these protrusions comprising components having a certain mass (batteries or accumulators, for example). These two weighted protrusions can ensure a certain stability of the sensor during its installation in particular, but also in a stationary position once it is installed. The upper part (PSup) of the sensor is that which overhangs the cable or the inspected immersed element. Within this upper part is located, in particular, the heating circuit (CEIC), the electronic temperature measuring circuit (CEMT) and the wireless transmission circuit, which in the present case is an acoustic transmission circuit linked to an acoustic transmission device (HPI). In this exemplary embodiment, the sensor is thus autonomous and the transmission of the temperature measurement data is performed, periodically by acoustic means. The acoustic transmission device (HPI) is located at the top of the sensor and is oriented towards the surface of the body of water within which the sensor is immersed. Such an orientation makes it possible, on the one hand, to transmit directly to the surface and can facilitate the operations for recording the transmitted data. In this exemplary embodiment, it is important that the acoustic transmission device (HPI) remains free of any biocolonisation. For this purpose, and as a minimum, the upper surface of the acoustic transmission device (HPI), which is in contact with the aqueous medium, is treated in order to prevent or limit biocolonisation. Such a treatment can be carried out by making the upper surface hydrophobic, or by using a suitable paint or coating. In certain exemplary embodiments, the entirety of the outer surface of the first part (P1) is treated to prevent biocolonisation: in this way it is simpler to repair the sensor when it is immersed and bonded/fixed to the cable and it is also simpler to provide it with underwater maintenance.

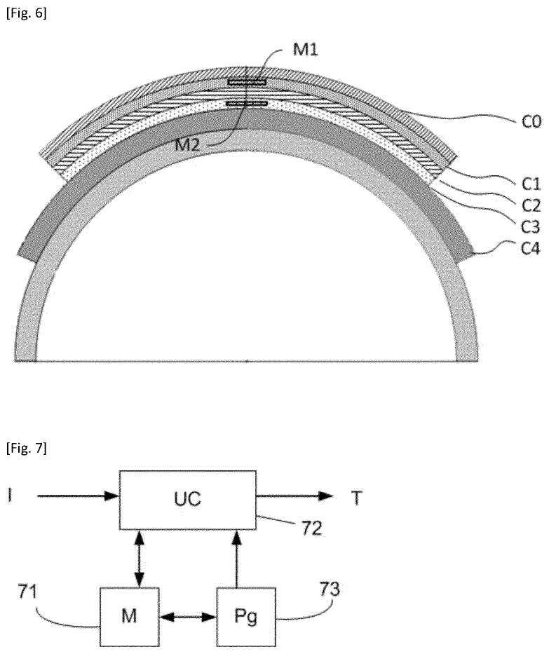

The second part of the sensor (P2) is in the form of a longitudinal protrusion starting in the first part and extending along the axis of the immersed element: this protrusion is intended to be biocolonised. It has a substantially hemicylindrical shape adapted to the shape of the immersed element on which it fits. The internal radius of curvature of the second part is therefore adapted to the outer radius of curvature of the immersed element (the cable), for which it is sought to measure the extent of biocolonisation. This second part globally consists of various layers and elements described in FIGS. 1, 2 and 3, with the exception of the power supply and electronic circuits, which are inserted in the first part (P1), as disclosed above. More particularly, in conjunction with FIG. 6, in an exemplary embodiment taking into account operational conditions, the second part consists of the following layers: a polymer support (coming into contact with the outer surface of the immersed element) serving as layer C4, a first insulating layer (C3), a heating layer (C2), a steel layer (C1) and a polymer layer (C0) of the same type as the outer wall of the underwater electrical cables and the external medium sensor assembly. The thickness of these layers is, in this exemplary embodiment, of order: 1 to 5 mm for C4, 1 to 5 mm for C3, 0.2 to 1 mm for C2, 1 to 3 mm for C1, preferably with the following values: 1 for C4, 1.9 mm for C3, 0.3 mm for C2, 1.6 mm for C1. The layer is of the same type as the electrical cable in order to have the same attachment conditions of biocolonisation as on the underwater cables.

In an exemplary embodiment (not shown), the measuring device of the disclosure comprises a third part, extending longitudinally along the device, opposite the second part. This third part is globally asymmetric with the second. This third part can be considered as being a second measurement arm. This second arm located on either side of the electronic unit (constituting the first part and containing the battery or accumulators) is covered with an anti-biocolonisation coating. In this configuration, the temperature measurement performed during and after the heating pulse is directly linked to the speed of the marine current. In this embodiment, with the two measuring arms (one being biocolonised and the other being free of any biocolonisation), a “differential” measuring device is obtained. Hence, in this embodiment (and in all the embodiments which implement a variation of this principle), the measuring device can also indirectly measure the speed of the marine current (factor to take into account) by adding a second measuring arm (or element) (covered with an anti-biocolonisation treatment) in order to have information on the effect of the flow of the marine current on the heat transfer around the immersed element, in other words enabling indirect measurement of the speed of the marine current. The other arm (part P2) covered with biocolonisation provides information on the effect of the biocolonisation added to the effect of the marine current. The assembly with two arms constitutes a “differential” device which can insulate the effect of the single biocolonisation and therefore characterise it more precisely and thus without (more or less significant) bias, linked to the effect of the marine current.

Using a device such as that described in the preceding figures, a measuring method is implemented, as described in conjunction with FIG. 4.

In an exemplary embodiment under operating conditions, the following features can be taken into consideration. They each have, in combination or individually, the peculiarity of allowing optimised obtaining of biocolonisation data from immersed elements (in particular electrical transmission cables for offshore wind turbines). The characteristics are as follows:
Heating duration 15 s to 10-15 min;
Recording duration of the cooling phase: 5 to 10 times the heating duration;
One or two temperature sensors consisting either of a thermocouple or a Pt 100 (depending on the on-board electronics);
Heating power of 5 to 100 W, depending on a possible prior visual characterisation of a preceding biocolonisation in the installation region of the sensor, for example.
The commands are transmitted acoustically to the sensor, just like the temperature readings, which are also transmitted acoustically from the sensor to the receiver. These readings comprise temperature readings, electrical power supply voltage readings, all as a function of time. These readings are implemented from the surface, vertically above the device, from a ship, with a predetermined periodicity (for example every quarter, half-year or more, depending on the type of biocolonisation).

In conjunction with FIG. 7, a simplified electronic architecture of the biocolonisation suitable for implementing the measurement method as presented above is described. Such a biocolonisation sensor comprises a memory 71, a processing unit 72, equipped for example with a microprocessor, and controlled by the computer programme 73, implementing the method according to the disclosure. In at least one embodiment, the invention is partially implemented in the form of an application installed on a communication device in possession of an entity, such as a user or a technician, and/or by means of a device uniquely dedicated to the reception of the acoustic data coming from the biocolonisation sensor. Such a biocolonisation sensor comprises, for example, all or part of the following means:
Data acquisition means (temperature and electrical voltage);
A storage memory, with a volatile memory as a minimum;
A heating control device;
An acoustic transmission and reception device;
Batteries or accumulators for the electronics and the heating (autonomous for 3 to 4 years, as a function of use);
Software code execution means as described above, these means being in the form of a specific software application, or even in the form of dedicated hardware components constructed with a view to carrying out these functions, such as a security element (SE) or a secure execution environment. The security element can be in the form of a Sim, USim or UICC card, or even a specific security component.

In a complementary manner, depending on the embodiments, it is possible to also read the temperatures at the sensor, in order to perform a temperature measurement of the water (which is not heated). This ambient temperature measurement of the water is carried out using a sensor on the surface of the upper part of the sensor, as far as possible away from the heating region and at the point where biocolonisation is not possible. Hence, in this embodiment, the temperature sensor of the water is located in the vicinity of the acoustic transmitter due to the presence, at the surface, of the treatment preventing biocolonisation.

1. A temperature measuring device configured to be applied to an immersed component in order to evaluate biocolonisation, the device comprising:
a heating element controllable by a heating circuit;
at least one temperature sensor, controlled by a temperature measuring circuit, the at least one temperature sensor able to sense temperature in a vicinity of the heating element, during a predetermined period;
at least one memory to store temperatures obtained by the temperature measuring circuit;
a data transmitter for transmitting temperature response data stored in the at least one memory;
a first part comprising a power supply for the temperature measuring device, the heating circuit, the temperature measuring circuit, the at least one memory and the data transmitter, the first part being distinct from a heating and measuring part, at least one portion of the first part comprising a treatment to limit biocolonisation.

2. The temperature measuring device according to claim 1, wherein the heating and measuring part has an overall hemicylindrical shape and comprises a plurality of layers comprising:
a supporting layer, to contact an outer surface of the immersed component;
an insulating layer insulating the supporting layer;
a heating layer, comprising said at least one heating element;
an accumulating metallic layer, for accumulating the heat produced by the heating layer.

3. The temperature measuring device according to claim 2, wherein the at least one temperature sensor comprises at least a first temperature sensor inserted within the accumulating layer and at least a second temperature sensor inserted within the insulating layer.

4. The temperature measuring device according to claim 1, wherein the data transmission module comprises an acoustic transmission component.

5. A system for obtaining data representative of the biocolonisation of the immersed component when the component is immersed in the open sea, the system being comprising:
at least one temperature measuring device according to claim 1; and
at least one processing device for processing temperature response data transmitted by said at least one temperature measuring device, said processing device being configured to characterise the biocolonisation of the immersed component as a function of the temperature response data.

6. A method comprising:
obtaining data representative of a biocolonisation of an immersed component in the open sea using, a system comprising:
at least one temperature measuring device comprising:
a heating element controllable by a heating circuit;
at least one temperature sensor, controlled by a temperature measuring circuit, the at least one temperature sensor able to sense temperature in a vicinity of the heating element, during a predetermined period;
at least one memory to store temperatures obtained by the temperature measuring circuit;
a data transmitter for transmitting temperature response data stored in the at least one memory;
a first part comprising a power supply for the temperature measuring device, the heating circuit, the temperature measuring circuit, the at least one memory and the data transmitter, the first part being distinct from a heating and measuring part, at least one portion of the first part comprising a treatment to limit biocolonisation; and
at least one processing device for processing temperature response data transmitted by said at least one temperature measuring device, said processing device being configured to characterise the biocolonisation of the immersed component as a function of the temperature response data,
wherein the obtaining comprises:
heating, during a predetermined period, said heating element of said at least one temperature measuring device;
a plurality of steps of measuring the temperature resulting from the heating;
storing the measured temperature, in particular comprising timestamping of the measured temperature; and subsequently,
transmitting the stored measured temperature as the temperature response data, followed by characterising the biocolonisation with the at least one processing device using the transmitted temperature response data.

7. The method according to claim 6, the characterising the biocolonisation using the transmitted temperature response data comprises calculating a heat transfer coefficient h of underwater fauna and flora constituting the biocolonisation, using a 1D analytical thermal model or a conductive thermal model solved by the quadrupole method.

8. A non-transitory computer readable medium comprising a computer program product comprising program code instructions for implementing the method for obtaining data representative of the biocolonisation according to claim 6, when the program is executed by a computer.
